(19) United States
(12) Patent Application Publication
(10) Pub. No.: US 2022/0222704 A1
(43) Pub. Date: Jul. 14, 2022

(54) SYSTEMS AND METHODS FOR CONTEXTUAL TARGETING

(71) Applicant: Comscore, Inc., Reston, VA (US)

(72) Inventors: William M. Knudsen, Fort Mill, SC (US); Vivek Arora, San Ramon, CA (US); Nathan Leaf, Prairie du Sac, WI (US); Raymond P. Smith, Lovettsville, VA (US)

(21) Appl. No.: 17/145,157

(22) Filed: Jan. 8, 2021

(51) Int. Cl. G06Q 30/02; G06F 16/955; G06F 16/23

(52) U.S. Cl. CPC G06Q 30/0255; G06F 16/2379; G06F 16/9566

(57) ABSTRACT

Data indicative of content associated with at least one content category may be received from a content provider. Data indicative of a plurality of consumer categories may also be received. A correlation between at least one consumer category of the plurality of consumer categories and the at least one content category may be determined. It may be determined if the correlation between the at least one consumer category and the at least one content category satisfies a threshold. If the correlation between the at least one consumer category and the at least one content category satisfies the threshold, the at least one consumer category may be associated to a profile associated with the at least one content category.

### BACKGROUND

Internet audience measurement may be useful for a number of reasons. For example, some organizations may want to make claims about the size and growth of their audiences or technologies. Similarly, understanding consumer behavior, such as how consumers interact with a particular website or group of websites, may help organizations make decisions that improve their traffic flow or the objective of their site. In addition, understanding Internet audience visitation and habits may be useful in supporting ad campaign planning, buying, and selling.

### SUMMARY

Methods and systems are disclosed for contextual targeting. A method for contextual targeting may comprise receiving, from a content provider, data indicative of content associated with at least one content category. The at least one content category may indicate a theme, subject matter, or topic prevalent in the content. Data indicative of a plurality of consumer categories may also be received. A correlation between at least one consumer category of the plurality of consumer categories and the at least one content category may be determined. It may be determined if the correlation between the at least one consumer category and the at least one content category satisfies a threshold. The correlation between the at least one consumer category and the at least one content category may satisfy the threshold if the correlation is greater than an average correlation between other consumer categories and the at least one content category. Conversely the correlation between the at least one consumer category and the at least one content category may not satisfy the threshold if the correlation is less than or equal to an average correlation between other consumer categories and the at least one content category.

If the correlation satisfies a threshold, the at least one consumer category may be associated to a profile associated with the at least one content category. The at least one content category may be associated to the profile by matching the at least one consumer category to the profile associated with the at least one content category. Conversely, if the correlation does not satisfy a threshold, the at least one consumer category should not be associated with the profile associated with the at least one content category. If it is determined that that a correlation between the at least one consumer category and a different content category instead satisfies the threshold, the at least one consumer category may be associated to a profile associated with the different content category. The at least one content category may be associated to the profile associated with the different content category by matching the at least one consumer category to the profile associated with the different content category. The profile associated with the at least one content category or the profile associated with the different content category may be indicated. For example, a profile associated with the at least one content category or a profile associated with the different content category may be forwarded to a supplemental content provider.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates a block diagram of an example environment;

FIG. 2 illustrates an example of a system in which a panel of users may be used to perform Internet audience measurement;

FIG. 3 illustrates an example of a system in which site centric data can be obtained by including beacon code in one or more web pages;

FIGS. 4A-B illustrate a flow chart of an example method;

FIG. 5 illustrates an exemplary response.

FIG. 6 illustrates a block diagram of an example computing device.

### DETAILED DESCRIPTION OF ILLUSTRATIVE EMBODIMENTS

Audience targeting may allow an advertiser to reach consumers based on who they are, their interests and habits, content they're actively consuming, or how they have interacted with certain businesses or websites. Audience targeting may boost an advertising campaign's performance by reaching consumers that are interesting in viewing the content of the advertisement. Accordingly, audience targeting may help improve the consumption experience for users as well as the success of an advertiser's campaign.

However, while it may be desirable to target audiences based on audience data, such as audience demographic information or audience behavior, it may not always be possible to do so. For example, audience data may not be available or it may be difficult to generate new audience data. In this case, it may be desirable to have a mechanism for predicting audiences based on information other than audience data. For example, it may be desirable to contextually predict audiences. To contextually predict audiences, content may be classified into at least one contextual category. The at least one contextual category may, for example, indicate a subject matter, theme, or topic prevalent in the content. Each contextual category may be associated with a profile that indicates those segments of consumers most likely to enjoy consuming content associated with that contextual category. Accordingly, audiences may be predicted using these contextual profiles rather than using audience data.

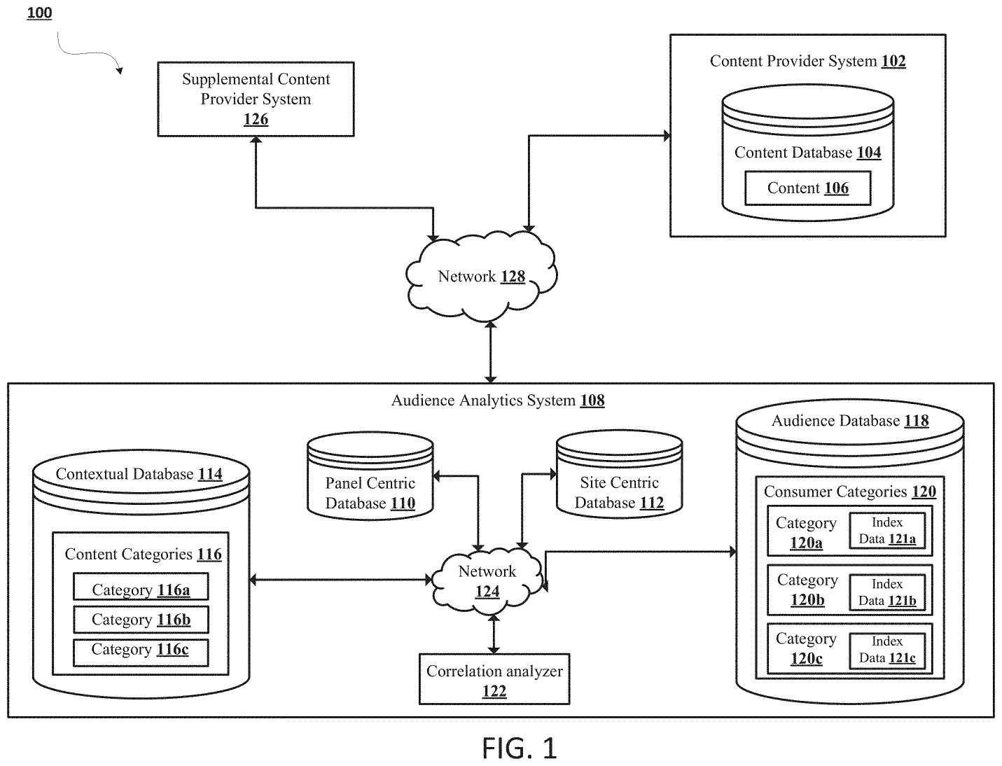

FIG. 1 illustrates an example hardware and network configuration in which the systems and methods described herein may be implemented. Such a hardware and network configuration 100 includes a content provider system 102, an audience analytics system 108, and a supplemental content provider system 126. The content provider system 102, the audience analytics system 108, and the supplemental content provider system 126 are in communication via a network 128.

The content provider system 102 may include a content database 104. The content database 104 may include content, such as the content 106. The content provider system 102 may be associated, for example, with a website provider or with a video content provider. If the content provider system 102 is associated with a website provider, the content 106 may include, for example, a website. If the content provider system 102 is associated with a video content provider, the content 106 may include, for example, video content. Video content may refer generally to any video content produced for viewer consumption regardless of the type, format, genre, or delivery method. Video content may comprise video content produced for broadcast via over-the-air radio, cable, satellite, or the internet. Video content may comprise digital video content produced for digital video streaming or video-on-demand. Video content may comprise a movie, a television show or program, an episodic or serial television series, or a documentary series, such as a nature documentary series. As yet another example, video content may include a regularly scheduled video program series, such as a nightly news program. The content 106 may be associated with one or more content distributors that distribute the content 106 to viewers for consumption.

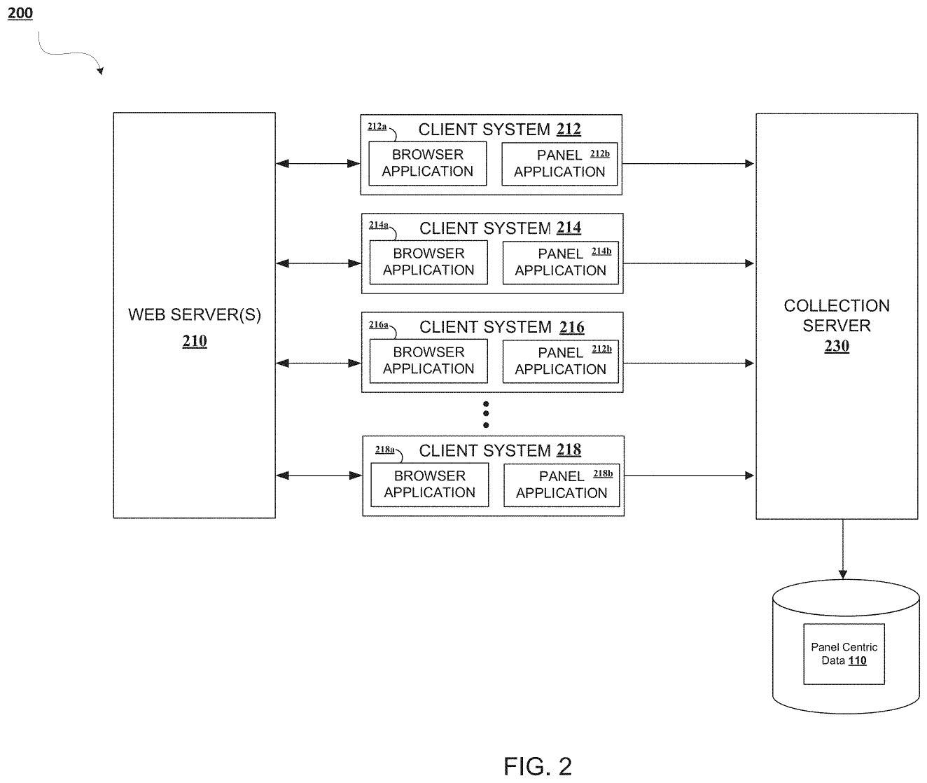

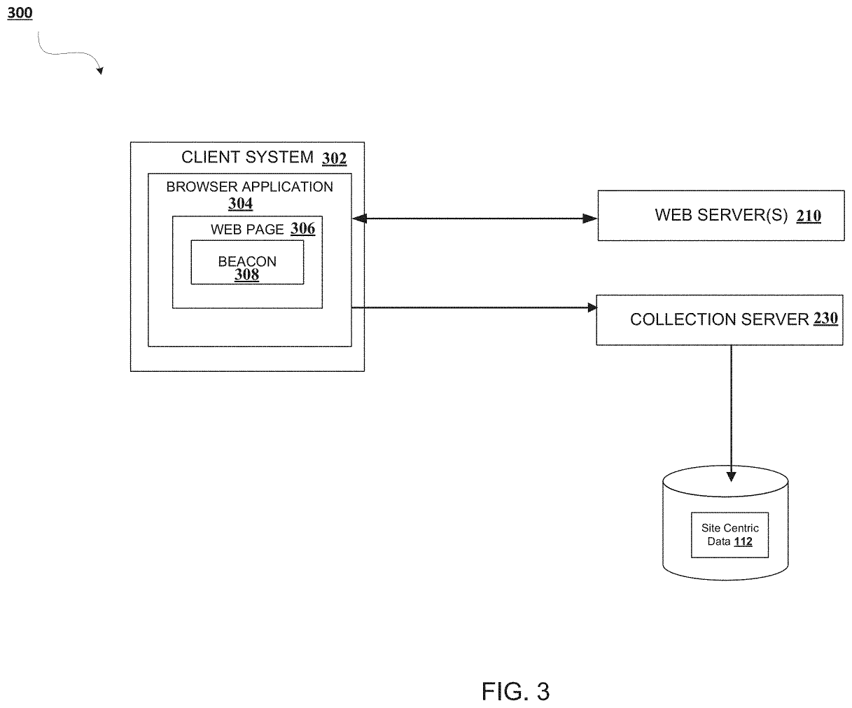

Each item of content 106 may be associated with at least one contextual category. Contextual categories may indicate at least one of a theme, a subject matter, or a topic that is prevalent in the content. For example, a website dedicated to tennis-related news may be associated with a “sports” contextual category. The contextual categories may be predetermined, for example, by an audience analytics system, such as the audience analytics system 108. For example, the contextual categories may be predetermined by the audience analytics system 108 and stored in the contextual database 114 as content categories 116. The content categories may include any number of content categories, such as the content categories 116a-c, indicating various themes, subject matters, or topics found in content. For example, the content categories 116 may include content categories indicating various themes, subject matters, or topics found in content that is found to be consumed based on panel centric data or site centric data, discussed below in regards to FIGS. 2-3.

The audience analytics system 108 may include a panel centric database 110, a site centric database 112, a contextual database 114, an audience database 118, and a correlation analyzer 122. The panel centric database 110, the site centric database 112, the contextual database 114, the audience database 118, and the correlation analyzer 122 are in communication via a network 124. The audience analytics system 108 may be associated with a business entity seeking to identify profiles for contextual audience targeting, such as the business entity described above.

The audience analytics system 108 may record webpage or other resource accesses by client systems, and those accesses may be analyzed to develop audience measurement reports. Data about resource accesses may be collected using a panel-based approach. This data collected using a panel-based approach (i.e. panel centric data) may, for example, be stored in the panel centric database 110. A panel-based approach generally entails installing a monitoring application on the client systems of a panel of users. The monitoring application then collects information about the webpage or other resource accesses and sends that information to a collection server.

FIG. 2 illustrates an example of a system 200 in which a panel of users may be used to collect data for Internet audience measurement. The system 200 includes client systems 212, 214, 216, and 218, one or more web servers 210, a collection server 230, and the panel centric database 110. In general, the users in the panel employ client systems 212, 214, 216, and 218 to access resources on the Internet, such as webpages, images, or video located at the web servers 210. Information about this resource access is sent by each client system 212, 214, 216, and 218 to a collection server 230. This information may be used to understand the usage habits of the users of the Internet.

Each of the client systems 212, 214, 216, and 218, the collection server 230, and the web servers 210 may be implemented using, for example, a computer, a server, or a mobile device. Client systems 212, 214, 216, and 218, collection server 230, and web servers 210 may receive instructions from, for example, a software application, a program, a piece of code, a device, a computer, a computer system, or a combination thereof, which independently or collectively direct operations. The instructions may be embodied permanently or temporarily in any type of machine, component, equipment, or other physical storage medium that is capable of being used by a client system 212, 214, 216, and 218, collection server 230, and web servers 210.

In the example shown in FIG. 2, the system 200 includes client systems 212, 214, 216, and 218. However, in other implementations, there may be more or fewer client systems. Similarly, in the example shown in FIG. 2, there is a single collection server 230. However, in other implementations there may be more than one collection server 230. For example, each of the client systems 212, 214, 216, and 218 may send data to more than one collection server for redundancy. In other implementations, the client systems 212, 214, 216, and 218 may send data to different collection servers. In this implementation, the data, which represents data from the entire panel, may be communicated to and aggregated at a central location for later processing. The central location may be one of the collection servers.

The users of the client systems 212, 214, 216, and 218 are a group of users that are a representative sample of the larger universe being measured, such as the universe of all Internet users or all Internet users in a geographic region. To understand the overall behavior of the universe being measured, the behavior from this sample is projected to the universe being measured. The size of the universe being measured and/or the demographic composition of that universe may be obtained, for example, using independent measurements or studies.

Similarly, the client systems 212, 214, 216, and 218 are a group of client systems that are a representative sample of the larger universe of client systems being used to access resources on the Internet. As a result, the behavior on a machine basis, rather than person basis, may also be, additionally or alternatively, projected to the universe of all client systems accessing resources on the Internet. The total universe of such client systems may also be determined, for example, using independent measurements or studies.

The users in the panel may be recruited by an entity controlling the collection server 230, and the entity may collect various demographic information regarding the users in the panel, such as age, sex, household size, household composition, geographic region, number of client systems, and household income. The techniques used to recruit users may be chosen or developed to help insure that a good random sample of the universe being measured is obtained, biases in the sample are minimized, and the highest manageable cooperation rates are achieved. Once a user is recruited, a monitoring application is installed on the user's client system. The monitoring application collects the information about the user's use of the client system to access resources on the Internet and sends that information to the collection server 230.

For example, the monitoring application may have access to the network stack of the client system on which the monitoring application is installed. The monitoring application may monitor network traffic to analyze and collect information regarding requests for resources sent from the client system and subsequent responses. For instance, the monitoring application may analyze and collect information regarding HTTP requests and subsequent HTTP responses.

Thus, in system 200, a monitoring application 212b, 214b, 216b, and 218b, also referred to as a panel application, is installed on each of the client systems 212, 214, 216, and 218. Accordingly, when a user of one of the client systems 212, 214, 216, or 218 employs, for example, a browser application 212a, 214a, 216a, or 218a to visit and view web pages, information about these visits may be collected and sent to the collection server 230 by the monitoring application 212b, 214b, 216b, and 218b. For instance, the monitoring application may collect and send to the collection server 230 the URLs of web pages or other resources accessed, the times those pages or resources were accessed, and an identifier associated with the particular client system on which the monitoring application is installed (which may be associated with the demographic information collected regarding the user or users of that client system). For example, a unique identifier may be generated and associated with the particular copy of the monitoring application installed on the client system. The monitoring application also may collect and send information about the requests for resources and subsequent responses. For example, the monitoring application may collect the cookies sent in requests and/or received in the responses. The collection server 230 receives and records this information. The collection server 230 aggregates the recorded information from the client systems and stores this aggregated information in the panel centric database 110 as panel centric data.

The panel centric data may be analyzed to determine the visitation or other habits of users in the panel, which may be extrapolated to the larger population of all Internet users. The information collected during a particular usage period (session) may be associated with a particular user of the client system (and/or his or her demographics) that is believed or known to be using the client system during that time period. Identifying the individual using the client system may allow the usage information to be determined and extrapolated on a per person basis, rather than a per machine basis. In other words, doing so allows the measurements taken to be attributable to individuals across machines within households, rather than to the machines themselves.

To extrapolate the usage of the panel members to the larger universe being measured, some or all of the members of the panel are weighted and projected to the larger universe. In some implementations, a subset of all of the members of the panel may be weighted and projected. For instance, analysis of the received data may indicate that the data collected from some members of the panel may be unreliable. Those members may be excluded from reporting and, hence, from being weighted and projected.

The reporting sample of users (those included in the weighting and projection) are weighted to insure that the reporting sample reflects the demographic composition of the universe of users to be measured, and this weighted sample is projected to the universe of all users. This may be accomplished by determining a projection weight for each member of the reporting sample and applying that projection weight to the usage of that member. Similarly, a reporting sample of client systems may be projected to the universe of all client systems by applying client system projection weights to the usage of the client systems. The client system projection weights are generally different from the user projection weights.

The usage behavior of the weighted and projected sample (either user or client system) may then be considered a representative portrayal of the behavior of the defined universe (either user or client system, respectively). Behavioral patterns observed in the weighted, projected sample may be assumed to reflect behavioral patterns in the universe.

Estimates of visitation or other behavior may be generated from this information. For example, this data may be used to estimate the number of unique visitors (or client systems) visiting certain web pages or groups of web pages, or unique visitors within a particular demographic visiting certain web pages or groups of web pages. This data may also be used to determine other estimates, such as the frequency of usage per user (or client system), average number of pages viewed per user (or client system), and average number of minutes spent per user (or client system).

Referring back to FIG. 1, the audience analytics system 108 may additionally, or alternatively, record webpage or other resource accesses by client systems, using a beacon-based approach. This data collected using a beacon-based approach (i.e. site centric data) may, for example, be stored in the site centric database 112. A beacon-based approach generally involves associating script or other code with the resource being accessed such that the code is executed when a client system renders or otherwise employs the resource. When executed, the beacon code sends a message to a collection server. The message includes certain information, such as an identifier of the resource accessed. Using the panel centric data, such as the data stored in the panel centric database 110, with data from a beacon-based approach, such as the data stored in the site centric database 112, may improve the overall accuracy of reports about audience visitation or other activity.

Referring to FIG. 3, a beacon-based approach may be implemented using a system 300. In general, a beacon-based approach may entail including beacon code in one or more web pages. The system 300 includes one or more client systems 302, the web servers 210, the collection servers 230, and the site centric database 112. The client systems 302 may include client systems 212, 214, 216, or 218, which have the panel application installed on them, as well as client systems that do not have the panel application installed.

The client systems 302 include a browser application 304 that retrieves web pages 306 from web servers 210 and renders the retrieved web pages. Some of the web pages 306 include beacon code 308. In general, publishers of web pages may agree with the entity operating the collection server 230 to include this beacon code in some or all of their web pages. This beacon code 308 is rendered with the web page in which the beacon code 308 is included. When rendered, the beacon code 308 causes the browser application 304 to send a message to the collection server 230. This message includes certain information, such as the URL of the web page in which the beacon code 308 is included. For example, the beacon code may be JavaScript code that accesses the URL of the web page on which the code is included and sends to the collection server 230 an HTTP Post message that includes the URL in a query string. Similarly, the beacon code may be JavaScript code that accesses the URL of the web page on which the code is included, and includes that in the URL in the “src” attribute of an <img> tag, which results in a request for the resource located at the URL in the “src” attribute of the <img> tag to the collection server 230. Because the URL of the webpage is included in the “src” attribute, the collection server 230 receives the URL of the webpage. The collection server 230 may then return a transparent image.

The collection server 230 records the webpage URL received in the message with, for instance, a time stamp of when the message was received and the IP address of the client system from which the message was received. The collection server 230 aggregates this recorded information and stores this aggregated information in the site centric database 112 as site centric data.

The message may also include a unique identifier for the client system. For example, when a client system first sends a beacon message to the collection server 230, a unique identifier may be generated for the client system (and associated with the received beacon message). That unique identifier may then be included in a cookie that is set on that client system 302. As a result, later beacon messages from that client system may have the cookie appended to them such that the messages include the unique identifier for the client system. If a beacon message is received from the client system without the cookie (e.g., because the user deleted cookies on the client system), then the collection server 230 may again generate a unique identifier and include that identifier in a new cookie set of the client system.

Thus, as users of client systems 302 access webpages (e.g., on the Internet), the client systems 302 access the webpages that include the beacon code, which results in messages being sent to the collection server 230. These messages indicate the webpage that was accessed (e.g., by including the URL for the webpage) and potentially a unique identifier for the client system that sent the message. When a message is received at the collection server 230, a record may be generated for the received message. The record may indicate an identifier (e.g., the URL) of the webpage accessed by the client system, the unique identifier for the client system, a time at which the client system accessed the webpage (e.g., by including a time stamp of when the message was received by the collection server 230), and a network address, such as an IP address, of the client system that accessed the webpage. The collection server 230 may then aggregate these records and store the aggregated records in the site centric database 112 as site centric data.

The beacon messages are generally sent regardless of whether or not the given client system has the panel application installed. But, for client systems in which the panel application is installed, the panel application also records and reports the beacon message to the collection server 230. For example, if the panel application is recording HTTP traffic, and the beacon message is sent using an HTTP Post message (or as a result of an <img> tag), then the beacon message is recorded as part of the HTTP traffic recorded by the panel application, including, for instance, any cookies that are included as part of the beacon message. Thus, in this instance, the collection server 230 receives the beacon message as a result of the beacon code, and a report of the beacon message as part of the panel application recording and reporting network traffic.

Because the beacon message is sent regardless of whether the panel application is installed, the site centric data directly represents accesses by the members of the larger universe to be measured, not just the members of the panel. As a result, for those web pages or groups of web pages that include the beacon code, the site-centric data may serve as the baseline for generating audience measurement data. However, for various reasons, this initial data may include some inaccuracies. The panel-centric data may be used to determine adjustment factors that may increase the accuracy of the site-centric data.

Referring back to FIG. 1, as discussed above, the contextual database 114 may include contextual categories, such as the content categories 116, that have been predetermined by the audience analytics system 108. The content categories 116 may include any number of content categories, such as the content categories 116a-c. Each content category 116 may indicate at least one of a theme, a subject matter, or a topic that is prevalent in content. For example, the content categories 116 may include content categories indicating various themes, subject matters, or topics found in content that is found to be consumed based on panel centric data or site centric data, discussed above with regard to FIGS. 2-3.

The audience database 118 may indicate consumer categories 120, such as the consumer categories 120a-c, and data associated with each of these consumer categories, such as the index data 121a-c. The consumer categories may include any number of categories. Each of the consumer categories may be a particular demographic category, an ethnicity category, an interest or lifestyle category, a viewing habit category, web browsing behavior, or any other category by which consumers may be categorized. For example, if the consumer category 120a is a demographic category, the consumer category 120a may be “females under the age of 20.” The consumer category 120a may be indicative of consumers that are females and under the age of 20. As another example, if the consumer category 120b is an interest or lifestyle category, the consumer category 120b may be “cooks.” The consumer category 120b may be indicative of consumers that enjoy cooking or baking. As another example, if the category 120c is a viewing habit category, the category 120c may be an “OTT consumer” category. The category 120c may be indicative of consumers that consume a large amount of subscription video-on-demand.

The consumer categories 120 may be based on data generated by the audience analytics system. For example, the consumer categories 120 may indicate various categories of consumers that are found to consume content based on panel centric data or site centric data, discussed above with regard to FIGS. 2-3. The consumer categories may additionally, or alternatively, be based on data that is generated by a third-party, such as a merchant that sells goods or services. For example, the consumer categories 120 may indicate various categories of consumers that are found to buy the merchant's goods or services, such as vehicles or television services.

The data associated with each of these consumer categories, such as the index data 121a-c, may indicate a correlation value between the consumer category and at least one of the content categories 116. The correlation value between the consumer category and a content category may indicate how likely consumers associated with the consumer category are to enjoy consuming content associated with the content category, or how frequently consumers associated with the consumer category consume content associated with the content category. The correlation values between each consumer category and each content category may be relative to one another. For example, a correlation value of “100” between a consumer category and a particular content category may indicate that the correlation between these two categories is average as compared to the remainder of the correlation values between other categories. Likewise, a correlation value of “160” between a consumer category and content category may indicate that the correlation between these two categories is higher than average as compared to the remainder of the correlation values between other categories. As another example, a correlation value of “80” between a consumer category and content category may indicate that the correlation between these two categories is lower than average as compared to the remainder of the correlation values between other categories.

For example, the plurality of consumer categories 120 may represent, as a whole, the general population. The correlation value between a particular consumer category and a content category may represent how frequently consumers associated with that particular consumer category visit content associated with that content category, as compared to how frequently the general population visits content associated with that content category. For example, the correlation value between a particular consumer category and a content category may represent how frequently the internet IDs associated with that particular consumer category visit content associated with that content category, as compared to how frequently all other internet IDs visit content associated with that content category.

The correlation analyzer 122 may implement a number of the functions and techniques described herein. For example, the correlation analyzer 122 may receive, from the contextual database 114, the content categories 116, such as the content categories 116a-c. If the correlation analyzer 122 and the contextual database 114 are associated with the same system, such as the audience analytics system 108, then the correlation analyzer 122 may receive the content categories 116 from the contextual database 114 by accessing the content categories 116 stored in the contextual database 114. The correlation analyzer 122 may also receive, from the audience database 118, the consumer categories 120. For example, the correlation analyzer 122 may receive the consumer categories 120a-c and the corresponding index data 121a-c. If the correlation analyzer 122 and the audience database 118 are associated with the same system, such as the audience analytics system 108, then the correlation analyzer 122 may receive the consumer categories 120 from the audience database 118 by accessing the consumer categories 120 stored in the audience database 118.

The correlation analyzer 122 may input the content categories 116 and the consumer categories 120 to determine which consumer categories over-index for a particular content category. For example, the correlation analyzer may determine which consumer categories have an index score above a predetermined threshold, such as “160.” As discussed above, a correlation value of “160” between a consumer category and content category may indicate that the correlation between these two categories is higher than average as compared to the remainder of the correlation values between other categories. As a result, a correlation value of “160” may indicate that consumers associated with the consumer category may enjoy consuming content associated with the content category more than an average consumer would. The correlation analyzer 122 may determine any number of consumer categories that over-index for a particular content category. For example, the correlation analyzer 122 may determine zero, two, ten, or hundreds of consumer categories that over-index for a particular content category. The correlation analyzer 122 may repeat this process for any number of content categories.

The correlation analyzer 122 may generate and output at least one profile associated with a content category 116. The profile associated with a content category 116 may indicate those consumer categories that over-indexed for the content category 116. For example, the profile associated with a content category 116 may indicate those consumer categories that have a correlation score of “160” or higher with the content category 116. The profile associated with a content category 116 may indicate any number of consumer categories that over-indexed for the content category 116. For example, the profile may indicate none, some, or all of the consumer categories that over-indexed for the content category 116. The profile may be used by a party, such as a supplemental content provider system 126, to select supplemental content, or advertisements, for insertion into content associated with the content category.

The content database 104, the panel centric database 110, the site centric database 112, the contextual database 114, the audience database 118, and the correlation analyzer 122 may each comprise one or more computing devices and/or network devices. The content database 104, the panel centric database 110, the site centric database 112, the contextual database 114, the audience database 118, and the correlation analyzer 122 may each comprise a data storage device and/or system, such as a network-attached storage (NAS) system. The networks 124, 128 may comprise one or more public networks (e.g., the Internet) and/or one or more private networks. A private network may include a wireless local area network (WLAN), a local area network (LAN), a wide area network (WAN), a cellular network, or an intranet. The networks 124, 128 may comprise wired network(s) and/or wireless network(s).

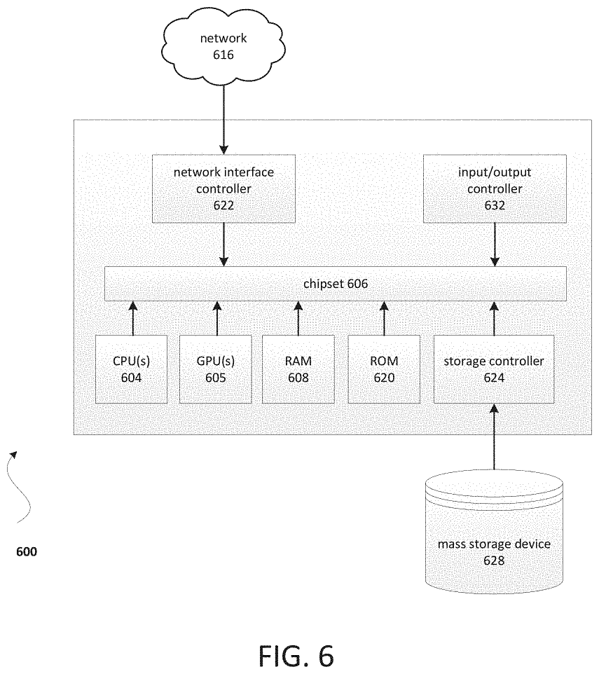

As noted, the content database 104, the panel centric database 110, the site centric database 112, the contextual database 114, the audience database 118, and the correlation analyzer 122 may each be implemented in one or more computing devices, such as the computing device 600 of FIG. 6.

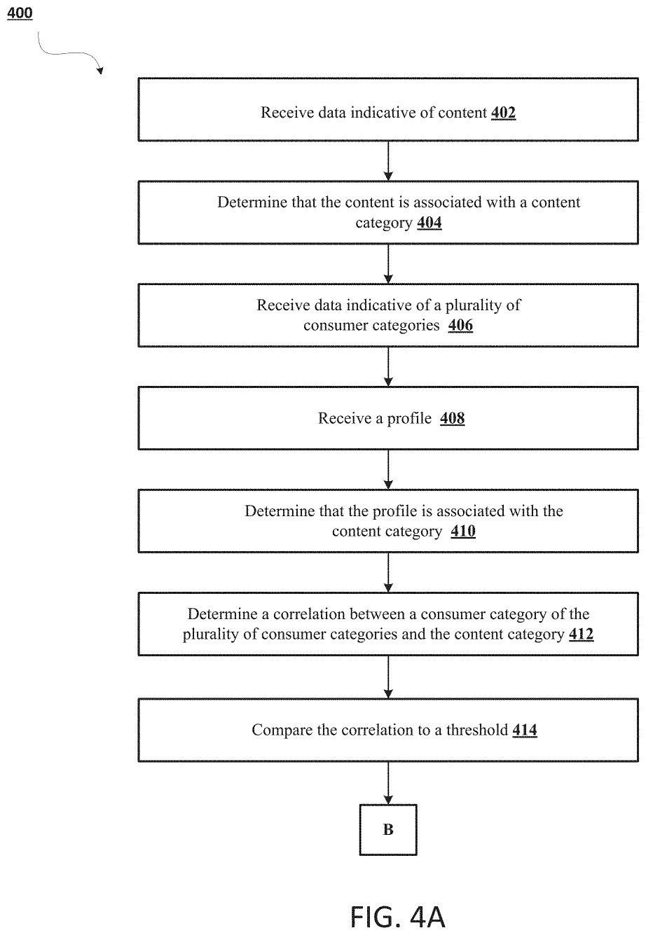

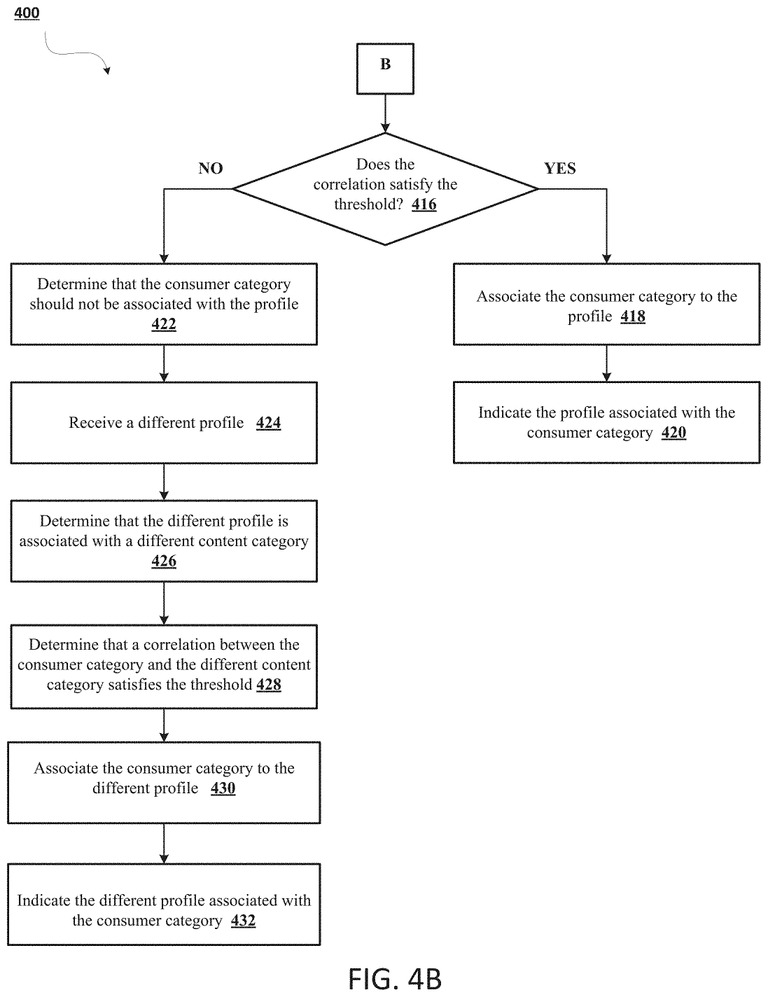

As discussed above, it may be desirable to have a mechanism for predicting audiences based on information other than audience data. For example, it may be desirable to contextually predict audiences. FIGS. 4A-B illustrate an exemplary method 400 for contextual audience prediction. The method 400 may be performed, for example, by the correlation analyzer 122 of FIG. 1. To contextually predict audiences, data indicative of content, such as a uniform resource locator (URL) for a website or other content, such as an image, audio, or video, may be received from a content provider. The content may be associated with at least one content category indicative of a theme, subject matter, or topic prevalent in the content. For example, a website may be associated with a “sports” content category or a video file may be associated with a “sports” content category. Consumer categories, such as demographic categories, ethnicity categories, interest or lifestyle categories, or viewing habit categories, that over-index with the content category may be associated to a profile associated with the content category. Audiences may be predicted using these contextual profiles rather than using audience data, which may be unavailable.

Starting at FIG. 4A, at step 402, data indicative of content, such as the content 106, may be received. The data indicative of content may be received, for example, from a content provider or from a DSP or supplemental content provider, such as the supplemental content provider system 126 of FIG. 1. For example, the data indicative of content may include a URL indicative of content. The data indicative of the content, such as the URL, may analyzed in order to associate the content to one or more contextual categories, such as the content categories 116. If the data indicative of the content is a URL, the webpage may need to be crawled in order to analyze it and associate the webpage to one or more contextual categories.

At step 404, it may be determined that the content is associated with at least one contextual category, such as a content category 116. As described above, contextual categories may indicate at least one of a theme, a subject matter, or a topic that is prevalent in the content. For example, a website dedicated to tennis-related news may be associated with a “sports” contextual category. The contextual categories may be predetermined, for example, by an audience analytics system, such as the audience analytics system 108. For example, the contextual categories may be predetermined by the audience analytics system 108 and stored in the contextual database 114 as content categories 116. The content categories may include any number of content categories, such as the content categories 116a-c, indicating various themes, subject matters, or topics found in content. For example, the content categories 116 may include content categories indicating various themes, subject matters, or topics found in content that is found to be consumed based on panel centric data or site centric data, discussed above in regard to FIGS. 2-3.

To contextually target audiences, it may be desirable to determine one or more consumer categories that over-index for the content category associated with the content. If the content is associated with more than one content category, it may be desirable to determine one or more consumer categories that over-index for each of the content categories. At step 406, data indicative of a plurality of consumer categories may be received. As discussed above, each consumer category, such as each of the consumer categories 120a-c, may be associated with data, such as the index data 121a-c. Each of the consumer categories may be a particular demographic category, an ethnicity category, an interest or lifestyle category, a viewing habit category, or any other category by which consumers may be categorized. For example, if the consumer category 120a is a demographic category, the consumer category 120a may be “females under the age of 20.” The consumer category 120a may be indicative of consumers that are females and under the age of 20. As another example, if the consumer category 120b is an interest or lifestyle category, the consumer category 120b may be “cooks.” The consumer category 120b may be indicative of consumers that enjoy cooking or baking. As another example, if the category 120c is a viewing habit category, the category 120c may be an “OTT consumer” category. The category 120c may be indicative of consumers that consume a large amount of subscription video-on-demand.

As also described above, the consumer categories 120 may be based on data generated by the audience analytics system. For example, the consumer categories 120 may indicate various categories of consumers that are found to consume content based on panel centric data or site centric data, discussed above with regard to FIGS. 2-3. The consumer categories may additionally, or alternatively, be based on data that is generated by a third-party, such as a merchant that sells goods or services. For example, the consumer categories 120 may indicate various categories of consumers that are found to buy the merchant's goods or services, such as vehicles or television services.

At step 408, a profile may be received. For example, a contextual profile may be received. At step 410, it may be determined that the profile is associated with a particular content category, such as the content category associated with the data received at step 402. To continue creating the profile, one or more consumer categories may be associated to the profile, as described below. For example, a consumer category may be associated to the profile if there is a relatively high correlation between the consumer category and the content category associated with the profile.

As described above, the data associated with each consumer category, such as the index data 121a-c, may indicate a correlation value between the consumer category and at least one of the content categories 116. At step 412, a correlation between a consumer category of the plurality of consumer categories and the content category may be determined. The correlation value between the consumer category and a content category may indicate how likely consumers associated with the consumer category are to continue consuming content associated with the content category, or how frequently consumers associated with the consumer category consume content associated with the content category. To determine the correlation between the consumer category and the content category, a regression model, such as a linear regression model, may be fitted to data associated with the at least one consumer category and data associated with the at least one content category.

The correlation values between each consumer category and each content category may be relative to one another. For example, a correlation value of “100” between a consumer category and a particular content category may indicate that the correlation between these two categories is average as compared to the remainder of the correlation values between other categories. Likewise, a correlation value of “160” between a consumer category and content category may indicate that the correlation between these two categories is higher than average as compared to the remainder of the correlation values between other categories. As another example, a correlation value of “80” between a consumer category and content category may indicate that the correlation between these two categories is lower than average as compared to the remainder of the correlation values between other categories.

At step 414, the correlation may be compared to a threshold. The threshold may be a correlation value that is indicative of a higher-than-average correlation between two categories. For example, the threshold may be an index value above “100,” such as “160.” If the correlation is higher than the threshold, the consumer category and the content category have a higher-than-average correlation. For example, if the correlation is higher than the threshold, the consumers associated with the consumer category may enjoy or continue consuming content associated with the content category more than an average consumer would. Conversely, if the correlation is less than or equal to the threshold, the consumer category and the content category have an average or lower-than-average correlation. For example, if the correlation is lower than the threshold, the consumers associated with the consumer category may enjoy or continue consuming content associated with the content category less than an average consumer would. If the correlation is equal to the threshold, the consumers associated with the consumer category may enjoy or continue consuming content associated with the content category as much as an average consumer would.

Comparing the correlation to the threshold may comprise determining the threshold. For example, comparing the correlation to the threshold may comprise determining the average correlation value between other consumer categories and the content category. To determine the average correlation value between other consumer categories and the content category, a correlation value indicative of a correlation between each of the other consumer categories and the content category may be determined and these correlation values may be averaged together.

As described above, the other consumer categories may represent, as a whole, the general population. The correlation value between a particular consumer category and a content category may represent how frequently consumers associated with that particular consumer category visit content associated with that content category, as compared to how frequently the general population visits content associated with that content category. For example, the correlation value between a particular consumer category and a content category may represent how frequently the internet IDs associated with that particular consumer category visit content associated with that content category, as compared to how frequently all other internet IDs visit content associated with that content category. If the other consumer categories, as a whole, represent the general population, determining the threshold may comprise determining the average correlation value between the content category and the general population, or total internet IDs.

Continuing to FIG. 4B, at step 416, it may be determined whether the correlation satisfies the threshold. If the correlation satisfies the threshold, the method 400 may proceed to step 418. The correlation may satisfy the threshold if the correlation is higher than the threshold. For example, the correlation may satisfy the threshold if the threshold is equal to the index value “160” and if the correlation is greater than “160.” In response, at step 418, the consumer category may be associated to the profile, such as the profile received at step 408. To associate the consumer category to the profile, the consumer category may be matched to the profile. The profile may already be associated with other consumer categories, or this consumer category may be the first consumer category associated to the profile.

The profile may be used by a party that is interested in contextual audience prediction. At step 420, the profile associated with the consumer category may be indicated. For example, the profile associated with the consumer category may be indicated to a DSP or supplemental content provider, such as the supplemental content provider system 126 of FIG. 1. Indicating the profile associated with the consumer category may comprise forwarding the profile to the supplemental content provider. The supplemental content provider may use the profile to determine supplemental content, such as advertisements, that are appropriate for insertion into content associated with the content category. For example, if the consumer category “tennis players” is associated to the profile for the content category “arts and entertainment,” a supplemental content provider that is seeking to insert supplemental content into “arts and entertainment” content may choose supplemental content that appeals to tennis players.

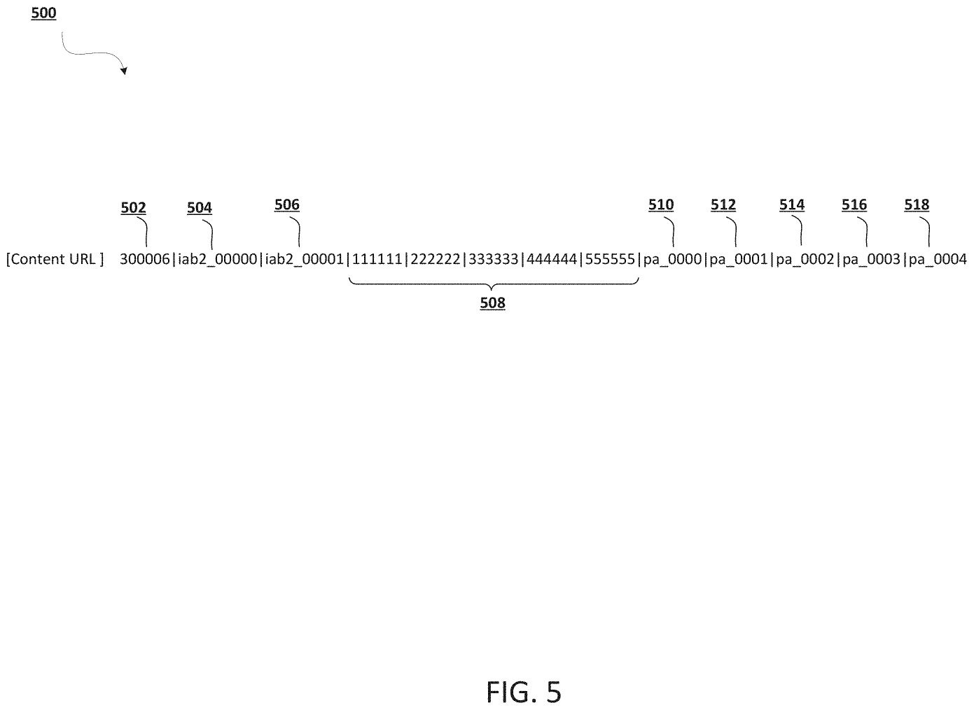

FIG. 5 illustrates an exemplary indication or response that may be sent, for example, to a DSP or supplemental content provider. The indication may include a list of segment IDs. The segment IDs may include all contextual categories and consumer categories determined to be associated with the content. For example, the content may be associated with the contextual categories indicated by segment IDs 502, 504, and 506. The segment ID 502 may indicate, for example, a brand safety category associated with the content. The segment IDs 504 and 506 may indicate, for example, the contextual categories, such as the content categories 116, associated with the content. The segment IDs 508 may indicate additional information associated with the content, such as various languages associated with the content. The segment IDs 510-518 may indicate, for example, the consumer categories determined to be associated with the content. For example, the segment IDs 510-518 may include those consumer categories that over-index for one or more of the contextual categories associated with the content, such as those indicated by segment IDs 502, 504, 506. For example, the segment ID 510 may indicate a consumer category, such as game console players. The segment ID 502 may indicate a content category, such as sports, and game console players may over-index for the content category “sports” based on visitation to sports-related content.

A particular consumer category, such as game console users, may be selected as a target audience ID for an ad campaign. For example, the consumer category indicated by the segment ID 510 may be selected as the target audience ID for an ad campaign. Each time a URL that is associated the segment ID 510 is received, such as at step 402, the indication 500 may be automatically sent to the DSP or supplemental content provider. As the indication 500 provides the contextual categories that have already been mapped to the target audience ID, the DSP or supplemental content provider may use the indication 500 to contextually target audiences.

Conversely, if the correlation does not satisfy the threshold, the method 400 may proceed to step 422. The correlation may not satisfy the threshold if the correlation is lower than or equal to the threshold. For example, the correlation may not satisfy the threshold if the threshold is equal to the index value “160” and if the correlation is equal to or less than “160.” In response, at step 422, it may be determined that the consumer category should not be associated with the profile. For example, it may be determined that consumers associated with the consumer category may not enjoy or continue consuming content associated with the content category more than an average consumer would.

The consumer category may instead be associated with one or more different content categories. For example, consumers associated with the consumer category may enjoy or continue consuming content associated with one or more different content categories more than an average consumer would. Accordingly, the consumer category may instead belong to one or more different profiles. At step 424, a different profile may be received. For example, the profile received at step 424 may be different than the profile received at step 408. At step 426, it may be determined that the different profile is associated with a different content category. For example, it may be determined that the different profile is associated with a different content category than the profile received at step 408.

Consumers associated with the consumer category may enjoy or continue consuming content associated with this different content category more than an average consumer would. At step 428, it may be determined that a correlation between the consumer category and the different content category satisfies the threshold. For example, it may be determined that the correlation satisfies the threshold if the correlation is higher than the threshold. For example, the correlation may satisfy the threshold if the threshold is equal to the index value “160” and if the correlation is greater than “160.” In response, at step 430, the consumer category may be associated to the different profile, such as the profile received at step 428. To associate the consumer category to the different profile, the consumer category may be matched to the different profile. The different profile may already be associated with other consumer categories, or this consumer category may be the first consumer category associated to the different profile.

The different profile may be used by a party that is interested in contextual audience prediction. At step 432, the different profile associated with the consumer category may be indicated. For example, the different profile associated with the consumer category may be indicated to a supplemental content provider, such as the supplemental content provider system 126 of FIG. 1. Indicating the different profile associated with the consumer category may comprise forwarding the profile to the supplemental content provider. The supplemental content provider may use the different profile to determine supplemental content, such as advertisements, that are appropriate for insertion into content associated with the different content category. For example, if the consumer category “chefs” is associated to the profile for the content category “cooking and baking,” a supplemental content provider that is seeking to insert supplemental content into “cooking and baking” content may choose supplemental content that appeals to chefs.

As described above, the indication 500 may include a list of segment IDs. The segment IDs may include all contextual categories and consumer categories determined to be associated with the content. For example, the content may be associated with the contextual categories indicated by segment IDs 502, 504, and 506. The segment ID 502 may indicate, for example, a brand safety category associated with the content. The segment IDs 504 and 506 may indicate, for example, the contextual categories, such as the content categories 116, associated with the content. The segment IDs 508 may indicate additional information associated with the content, such as various languages associated with the content. The segment IDs 510-518 may indicate, for example, the consumer categories determined to be associated with the content. For example, the segment IDs 510-518 may include those consumer categories that over-index for one or more of the contextual categories associated with the content, such as those indicated by segment IDs 502, 504, 506. For example, the segment ID 510 may indicate a consumer category, such as game console players. The segment ID 502 may indicate a content category, such as sports, and game console players may over-index for the content category “sports” based on visitation to sports-related content.

A particular consumer category, such as game console users, may be selected as a target audience ID for an ad campaign. For example, the consumer category indicated by the segment ID 510 may be selected as the target audience ID for an ad campaign. Each time a URL that is associated the segment ID 510 is received, such as at step 402, the indication 500 may be automatically sent to the DSP or supplemental content provider. As the indication 500 provides the contextual categories that have already been mapped to the target audience ID, the DSP or supplemental content provider may use the indication 500 to contextually target audiences. FIG. 6 depicts a computing device that may be used in various aspects. With regard to the example environment of FIG. 1, one or more of the content database 104, the panel centric database 110, the site centric database 112, the contextual database 114, the audience database 118, or the correlation analyzer 122 may be implemented in an instance of a computing device 600 of FIG. 6. The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in FIGS. 4A-B.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A user interface may be provided between the CPU(s) 604 and the remainder of the components and devices on the baseboard. The interface may be used to access a random access memory (RAM) 608 used as the main memory in the computing device 600. The interface may be used to access a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein. The user interface may be provided by a one or more electrical components such as the chipset 606.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a storage device 628 that provides non-volatile storage for the computer. The storage device 628 may store system programs, application programs, other program modules, and data, which have been described in greater detail herein. The storage device 628 may be connected to the computing device 600 through a storage controller 624 connected to the chipset 606. The storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the storage device 628 is characterized as primary or secondary storage and the like.

For example, the computing device 600 may store information to the storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may read information from the storage device 628 by detecting the physical states or characteristics of one or more particular locations within the physical storage units.

In addition or alternatively to the storage device 628 described herein, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A storage device, such as the storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The storage device 628 may store other system or application programs and data utilized by the computing device 600.

The storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described herein. The computing device 600 may have access to computer-readable storage media storing computer-executable instructions, which, when executed by the computing device 600, may perform the methods described in relation to FIGS. 4A-B.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of service software may be stored on or transmitted across some form of computer-readable media. Any of the disclosed methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
collecting, using an application installed on one or more devices associated with a panel of users, data indicative of content consumed by the panel of users, the content associated with at least one content category;
receiving data indicative of a plurality of consumer categories;
determining that a correlation between at least one consumer category of the plurality of consumer categories and the at least one content category satisfies a threshold; and
associating, based on the correlation satisfying the threshold, the at least one consumer category to a profile associated with the at least one content category.

2. The method of claim 1, wherein determining that the correlation between the at least one consumer category and the at least one content category satisfies the threshold comprises:
determining that the correlation between the at least one consumer category and the at least one content category is greater than an average correlation between other consumer categories of the plurality of consumer categories and the at least one content category.

3. The method of claim 2, further comprising determining the average correlation between the other consumer categories and the at least one content category by:
determining a correlation value indicative of a correlation between each of the other consumer categories and the at least one content category; and
averaging the correlation values.

4. The method of claim 1, wherein determining that the correlation between the at least one consumer category and the at least one content category satisfies the threshold comprises comparing the correlation between the at least one consumer category and the at least one content category to the threshold.

5. The method of claim 1, further comprising:
receiving a profile; and
determining that the profile is associated with the at least one content category.

6. The method of claim 5, wherein associating, based on the correlation satisfying the threshold, the at least one consumer category to the profile associated with the at least one content category comprises:
matching the at least one consumer category to the profile associated with the at least one content category.

7. The method of claim 1, further comprising:
determining that a correlation between a different consumer category of the plurality of consumer categories and the at least one content category does not satisfy the threshold; and
determining, based on the correlation not satisfying the threshold, that the different consumer category should not be associated with the profile associated with the at least one content category.

8. The method of claim 7, wherein determining that the correlation between the different consumer category and the at least one content category does not satisfy the threshold comprises:
determining that the correlation between the different consumer category and the at least one content category is less than or equal to an average correlation between other consumer categories of the plurality of consumer categories and the at least one content category.

9. The method of claim 7, further comprising:
determining that a correlation between the different consumer category and a different content category satisfies the threshold; and
associating, based on the correlation satisfying the threshold, the different consumer category to a profile associated with the different content category.

10. The method of claim 1, wherein the plurality of consumer categories comprises at least one of a demographic category, an ethnicity category, an interest or lifestyle category, or a viewing habit category.

11. The method of claim 1, wherein the data indicative of the plurality of consumer categories comprises data indicative of consumer purchasing behavior associated with each of the plurality of consumer categories.

12. The method of claim 1, wherein the data indicative of the plurality of consumer categories comprises data indicative of consumer web browsing behavior associated with each of the plurality of consumer categories.

13. The method of claim 1, wherein the data indicative of the plurality of consumer categories comprises data indicative of consumer television watching habits associated with each of the plurality of consumer categories.

14. The method of claim 1, wherein the at least one content category comprises at least one of a theme, topic, or subject matter associated with content.

15. The method of claim 1, further comprising:
indicating the profile associated with the at least one content category.

16. The method of claim 1, wherein the content is a website, and wherein receiving the data indicative of the content associated with the at least one content category comprises receiving a universal resource locator (URL) associated with the website and a time that the URL was consumed.

17. The method of claim 1, wherein receiving the data indicative of the plurality of consumer categories comprises accessing, from a database, the data indicative of the plurality of consumer categories.

18. The method of claim 1, further comprising determining the correlation between the at least one consumer category and the at least one content category by fitting a regression model to data associated with the at least one consumer category and data associated with the at least one content category.

19. A system comprising:
at least one processor; and
at least one memory storing instructions that, when executed, cause the at least one processor to:
collect, using an application installed on one or more devices associated with a panel of users, data indicative of content consumed by the panel of users, the content associated with at least one content category;
receive data indicative of a plurality of consumer categories;
determine that a correlation between at least one consumer category of the plurality of consumer categories and the at least one content category satisfies a threshold; and
associate, based on the correlation satisfying the threshold, the at least one consumer category to a profile associated with the at least one content category.

20. A non-transitory computer-readable medium storing instructions that, when executed, cause:
collecting, using an application installed on one or more devices associated with a panel of users, data indicative of content consumed by the panel of users, the content associated with at least one content category;
receiving data indicative of a plurality of consumer categories;
determining that a correlation between at least one consumer category of the plurality of consumer categories and the at least one content category satisfies a threshold; and
associating, based on the correlation satisfying the threshold, the at least one consumer category to a profile associated with the at least one content category.

21. The method of claim 1, wherein the application is configured to collect information regarding HTTP requests and subsequent HTTP responses.

22. The method of claim 1, wherein the application is configured to collect the URLs of web pages accessed by the panel of users, times the web pages were accessed by the panel of users, and an identifier associated with the particular device on which the application is installed.

23. The method of claim 22, wherein the identifier associated with the particular device is indicative of demographic information associated with one or more users associated with the particular device, the one or more users belonging to the panel of users.
